(19) United States
(12) Patent Application Publication
(10) Pub. No.: US 2006/0264241 A1
(43) Pub. Date: Nov. 23, 2006

(54) Base station log collection device, method for collecting logs of base station and computer program product

(75) Inventors: Shinichi Koyamatsu, Fukuoka (JP); Kazuo Yano, Fukuoka (JP)

Correspondence Address: BINGHAM MCCUTCHEN LLP, 3000 K STREET, NW, BOX IP, WASHINGTON, DC, 20007, US

(73) Assignee: FUJITSU LIMITED

(21) Appl. No.: 11/492,065

(22) Filed: Jul. 25, 2006

(30) Foreign Application Priority Data
Apr. 18, 2000 (JP) 2006-114438

(51) Int. Cl. H04B 1/38

(52) U.S. Cl. 455/561

(57) ABSTRACT

A device and method is provided for reducing the cost involved in bases for colleting logs of base stations compared to conventional cases. A remote log collection device includes a bus interface for connecting to a wireless base station device, a wire communications network interface or a wireless communications network interface corresponding to a communications network different from a communications network used for the wireless base station device, a log data entry control portion for controlling the bus interface so that log data indicating contents of a process performed in the wireless base station device are entered, a RAM for storing the entered log data, and a log transmission control portion for controlling the wire communications network interface or the wireless communications network interface so that the log data stored in the RAM are transmitted to a maintenance device.

### BACKGROUND OF THE INVENTION

### Field of the Invention

The present invention relates to a device and method for collecting logs of a base station for a wireless network such as a mobile telephone network or a PHS network.

Mobile communications such as mobile telephones and PHS have recently been widespread. Telecommunication companies (carriers) increase bases (infrastructures) such as base stations, switching centers and others every day in order to expand the area where the mobile communications are available. In addition, the telecommunication companies perform maintenance on the bases every day in order to maintain the communications quality.

The telecommunication companies should install base stations at various locations in a wide area with the base stations being away from one another.

If trouble occurs in a base station, a case may arise where subscribers cannot use services. In order to avoid such a situation, the telecommunication companies are required to monitor the states of the base stations to prevent trouble from occurring. Besides, even if trouble occurs in a base station, the telecommunication companies are required to deal with the trouble promptly.

To those ends, collecting logs of the base stations are necessary. As described above, however, since the base stations are installed at various locations separately from one another, it is difficult for maintenance staffs to visit all the base stations for collecting logs. Accordingly, there is proposed a method described in Japanese unexamined patent publication No. 4-242396.

According to the method described in the publication, a supervisory controller logging and sending supervisory information is provided to each piece of supervised equipment at remote locations. The supervisory controller is connected to a center logging system via a communications line. The supervisory controller transfers the logged monitor information to the logging system at regular intervals.

It is necessary for maintenance staffs of the telecommunication companies to monitor whether or not a base station that has just been established operates stably in a detailed manner. However, after confirming that the base station operates stably, it is not always good to monitor the base station in a detailed manner. The reason is that detailed monitoring despite little trouble is inefficient in respect of human resources.

The telecommunication companies are requested by subscribers to lower telecommunication fees. A possible method for meeting their request is to reduce the cost of bases.

### SUMMARY OF THE INVENTION

The present invention is directed to solve the problems pointed out above, and therefore, an object of the present invention is to reduce the cost involved in bases for colleting logs of base stations compared to conventional cases.

According to one aspect of the present invention, a base station log collection device that is to be placed in a location of a base station to be maintained and is used for collecting logs of the base station, the device includes a base station interface that is an interface for connecting to the base station to be maintained, a communications network interface corresponding to a communications network different from a communications network used for the base station, a log data entry control portion for controlling the base station interface so that log data indicating contents of a process performed in the base station are entered from the base station, a storage portion for storing the entered log data, and a log data transmission control portion for controlling the communications network interface so that the log data stored in the storage portion are transmitted to a maintenance device used by a maintenance staff of the base station.

Preferably, the log data transmission control portion controls the communications network interface so that the log data are transmitted to the maintenance device based on a command issued by the maintenance device.

Further, the base station log collection device includes, as the communications network interface, a wire communications network interface corresponding to a wire communications network and a wireless communications network interface corresponding to a wireless communications network. The log data transmission control portion controls either one of the wire communications network interface and the wireless communications network interface to transmit the log data, the either one being selected by the maintenance device.

The present invention makes it possible to reduce the cost involved in bases for colleting logs of base stations compared to conventional cases.

These and other characteristics and objects of the present invention will become more apparent by the following descriptions of preferred embodiments with reference to drawings.

### BRIEF DESCRIPTION OF THE DRAWINGS

FIG. 1 is a diagram showing an example of a communications system including a remote log collection device according to the present invention, a wireless base station device and a maintenance terminal.

FIG. 2 is a diagram showing an example of a hardware configuration of the remote log collection device.

FIG. 3 is a diagram showing an example of a functional configuration of the remote log collection device.

FIG. 4 is a diagram showing an example of a hardware configuration of the wireless base station device.

FIG. 5 is a diagram showing an example of a functional configuration of the maintenance terminal.

FIG. 6 is a list showing an example of commands prepared in the remote log collection device.

FIG. 7 is a flowchart for explaining an example of the entire process flow in the remote log collection device.

FIG. 8 is a flowchart for explaining an example of the entire process flow in the maintenance terminal.

FIG. 9 is a flowchart for explaining an example of a flow of a log collection process.

### DESCRIPTION OF THE PREFERRED EMBODIMENTS

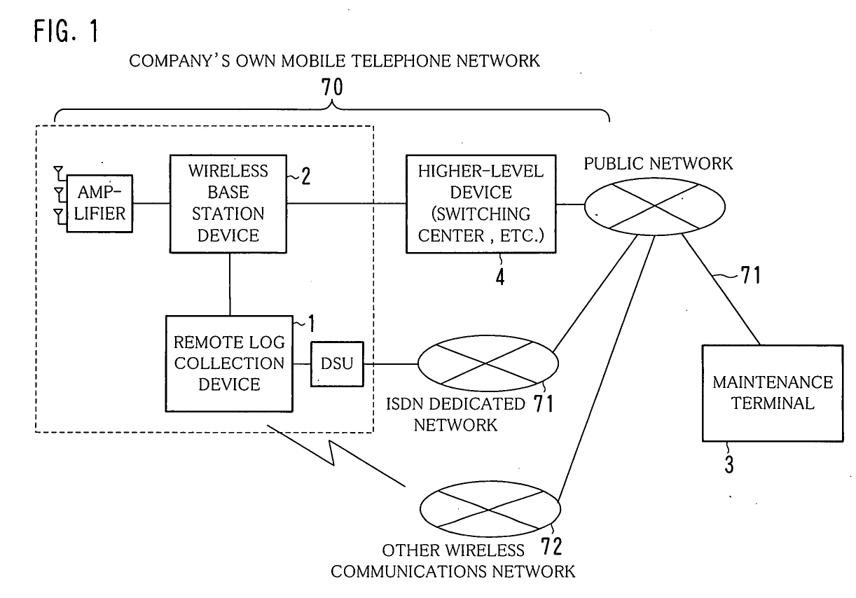

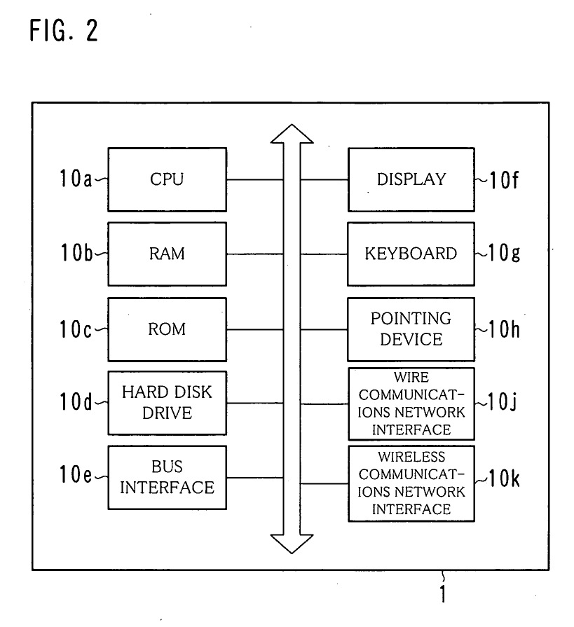

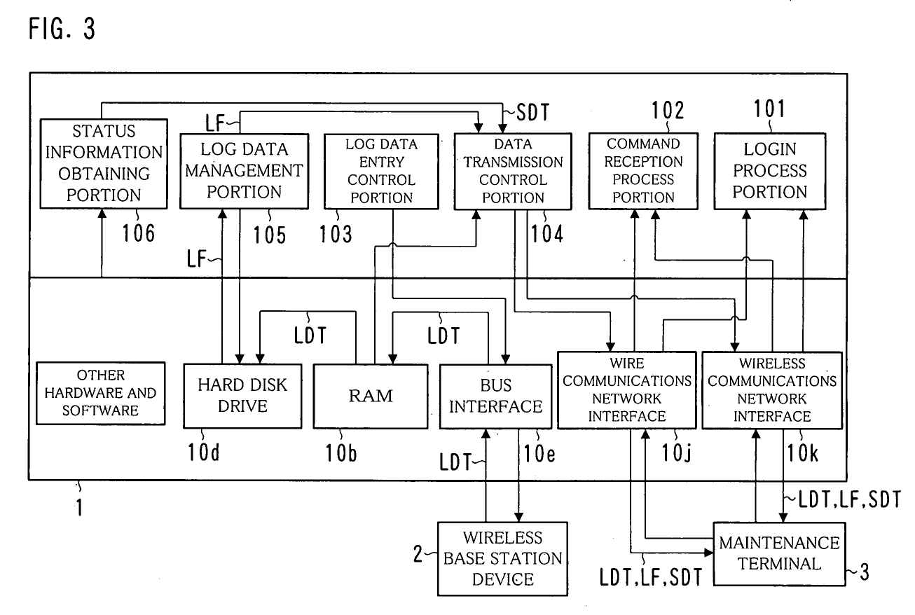

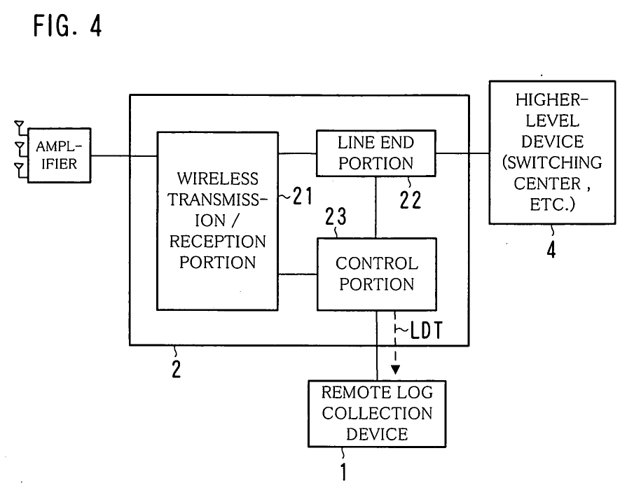

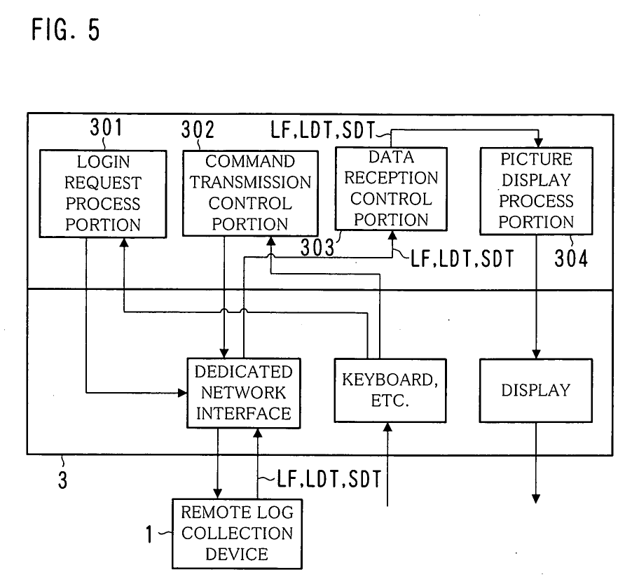

FIG. 1 is a diagram showing an example of a communications system including a remote log collection device 1 according to the present invention, a wireless base station device 2 and a maintenance terminal 3, FIG. 2 is a diagram showing an example of a hardware configuration of the remote log collection device 1, FIG. 3 is a diagram showing an example of a functional configuration of the remote log collection device 1, FIG. 4 is a diagram showing an example of a hardware configuration of the wireless base station device 2, FIG. 5 is a diagram showing an example of a functional configuration of the maintenance terminal 3.

Referring to FIG. 1, the remote log collection device 1 according to the present invention is used for collecting logs of the wireless base station device 2 that is a base station for a wireless communications network such as a mobile telephone network or a PHS network.

The following is a description of a case in which a telecommunication company X that provides users with communications services using the company's own mobile telephone network collects logs of the wireless base station device 2 used for the communications for the purpose of performing maintenance on the wireless base station device 2. Hereinafter, the mobile telephone network of the telecommunication company X is referred to as a “company's own mobile telephone network 70”.

As shown in FIG. 2, the remote log collection device 1 includes a CPU 10a, a RAM 10b, a ROM 10c, a hard disk drive 10d, a bus interface 10e, a display 10f, a keyboard 10g, a pointing device 10h, a wire communications network interface 10j and a wireless communications network interface 10k. The remote log collection device 1 can be a personal computer, a workstation or others. While the remote log collection device 1 may be a desktop type, it is preferably a laptop type.

The bus interface 10e is an interface for connecting the remote log collection device 1 to the wireless base station device 2. The bus interface 10e can be USB, IEEE1394, RS-232C, SCSI or others.

The wire communications network interface 10j is an interface for connecting to other devices installed at remote locations via a wire communications network. In the present embodiment, it is supposed that an ISDN standard dedicated network is used as the wire communications network. Accordingly, a terminal adapter is used as the wire communications network interface 10j. Hereinafter, the wire communications network is referred to as an “ISDN dedicated network 71”.

The wireless communications network interface 10k is an interface for connecting to other devices installed at remote locations via a wireless communications network other than the company's own mobile telephone network 70, e.g., a mobile telephone network owned by other company, a PHS network owned by the telecommunication company X or a PHS network owned by other company. Hereinafter, such a wireless communications network is referred to as an “other wireless communications network 72”. The wireless communications network interface 10k can be a data communications card of a PC card type corresponding to the other wireless communications network 72.

The display 10f serves to display various types of information. The keyboard 10g and the pointing device 10h are used to directly operate the remote log collection device 1 by a staff in charge of maintenance of the wireless base station device 2 (hereinafter referred to as a “maintenance staff”). The maintenance staff can operate the remote log collection device 1 also from a remote location by using the maintenance terminal 3 that is described later.

Referring to FIG. 3, on the hard disk drive 10d are installed programs and data for achieving functions including a login process portion 101, a command reception process portion 102, a log data entry control portion 103, a data transmission control portion 104, a log data management portion 105 and a status information obtaining portion 106. These programs and data are loaded into the RAM 10b if necessary and the programs are executed by the CPU 10a. The process contents of each of the portions shown in FIG. 3 are described later.

Referring back to FIG. 1, the wireless base station device 2 is a base station (wireless station) that performs a process for controlling connection of mobile telephone terminals of users who subscribe to mobile telephone communications services provided by the telecommunication company X and a process for relaying the communications between the mobile telephone terminals and a higher-level device 4 in the company's own mobile telephone network 70. Among the higher-level device 4 is a transmission device, a wireless base station controller or a mobile switching device (a switching center).

As shown in FIG. 4, the wireless base station device 2 includes a wireless transmission/reception portion 21, a line end portion 22 and a control portion 23.

The line end portion 22 is an interface for communicating with the higher-level device 4 via a wire transmission line 70a.

The control portion 23 includes a variety of control programs and performs various control operation based on control signals output from the higher-level device 4. The control portion 23 further includes an interface for monitoring states of operation of these control programs and hardware using the remote log collection device 1, i.e., for outputting operation logs of the control programs and hardware. The interface is connected to the bus interface 10e of the remote log collection device 1 with a cable, making it possible to exchange data between the wireless base station device 2 and the remote log collection device 1.

The wireless transmission/reception portion 21 exchanges signals with the higher-level device 4 and a mobile telephone terminal. On this occasion, the wireless transmission/reception portion 21 performs a process for converting a signal transmitted from the higher-level device 4 via the wire transmission line 70a to a signal of a type corresponding to a wireless transmission line 70b, a process for converting a signal transmitted from a mobile telephone terminal via the wireless transmission line 70b to a signal of a type corresponding to the wire transmission line 70a, a multiple separation process and an error code decoding process. The wireless transmission/reception portion 21 is connected to a transmission amplifier and a reception amplifier. The transmission amplifier and the reception amplifier serve to amplify a signal transmitted from a mobile telephone terminal to output the amplified signal to the wireless transmission/reception portion 21 or to amplify a transmission signal delivered from the wireless transmission/reception portion 21 toward a mobile telephone terminal to output the amplified signal wirelessly.

The maintenance terminal 3 is installed in a maintenance center that is the business base for maintenance staffs. The maintenance terminal 3 can control the remote log collection device 1 remotely via the ISDN dedicated network 71 or the other wireless communications network 72 to obtain logs of the wireless base station device 2.

The maintenance terminal 3 establishes the connection with the remote log collection device 1 in the following procedure. When being turned ON, the maintenance terminal 3 displays a call picture on a display. A maintenance staff selects any one of a telephone number corresponding to the wire communications network interface 10j and a telephone number corresponding to the wireless communications network interface 10k in the remote log collection device 1.

Responding to this selection, a dedicated network interface of the maintenance terminal 3 makes a call to the telephone number to establish the connection with the remote log collection device 1. When connection is established by making a call to the telephone number corresponding to the wire communications network interface 10j, the ISDN dedicated network 71 is used as the communications network. When connection is established by making a call to the telephone number corresponding to the wireless communications network interface 10k, the ISDN dedicated network 71, the other wireless communications network 72 and other public networks for relaying them, and others are used as the communications network.

The maintenance terminal 3 can be a personal computer, a workstation, a server machine or others. The hardware configuration of the maintenance terminal 3 is basically the same as the hardware configuration of the remote log collection device 1 described with reference to FIG. 2. Note that a mobile telephone line network interface is not essential in the present embodiment.

Referring to FIG. 5, on a hard disk drive of the maintenance terminal 3 are installed programs and data for achieving functions including a login request process portion 301, a command transmission control portion 302, a data reception control portion 303 and a picture display process portion 304. These programs and data are loaded into a RAM if necessary and the programs are executed by a CPU.

Hereinafter, of two of the wire communications network interface 10j and the wireless communications network interface 10k on the remote log collection device 1 side, the interface where the connection to the maintenance terminal 3 is established is referred to as a “connection establishment interface”.

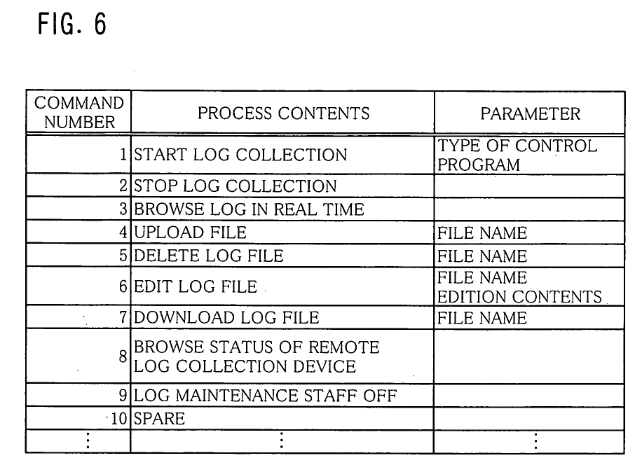

FIG. 6 is a list showing an example of commands prepared in the remote log collection device 1. Next, a description is provided of process contents of each of the portions included in the remote log collection device 1 shown in FIG. 3 and of each of the portions included in the maintenance terminal 3 shown in FIG. 5.

Referring to FIG. 5, when a maintenance staff performs operation for entering an ID and a password necessary for logging into the remote log collection device 1, the login request process portion 301 in the maintenance terminal 3 controls the dedicated network interface so as to transmit the ID and the password to the remote log collection device 1. Responding to this, the dedicated network interface establishes the connection with the remote log collection device 1 to send the ID and the password thereto.

Referring to FIG. 3, after booting up, the remote log collection device 1 performs self-checking operation. Then, unless an abnormality is found, the login process portion 101 in the remote log collection device 1 waits for a login request made by the maintenance staff. When receiving the user ID and the password from the maintenance terminal 3, the login process portion 101 performs a user authentication process. After confirming that the maintenance staff is an authorized user, the login process portion 101 sends an ACK (Acknowledgement) signal to the maintenance terminal 3. Thereby, the login process of the maintenance staff to the remote log collection device 1 is completed.

When the maintenance staff logging into the remote log collection device 1 performs operation for entering a command for controlling the remote log collection device 1, the command transmission control portion 302 in the maintenance terminal 3 controls the dedicated network interface so as to send to the remote log collection device 1 the command and necessary data, e.g., parameter values of a process pertaining to the command. Commands defined by command numbers “1” to “9” as shown in FIG. 6 are prepared as the commands for controlling the remote log collection device 1. The meaning of each of the commands is described later one by one.

The command reception process portion 102 in the remote log collection device 1 performs a process for accepting a command sent from the maintenance terminal 3. More specifically, when the connection establishment interface (the wire communications network interface 10j or the wireless communications network interface 10k) receives the command and necessary data sent from the maintenance terminal 3, the command reception process portion 102 issues instructions to each of the portions so that a process corresponding to the contents of the command is performed.

The log data entry control portion 103 performs a process corresponding to the command number “1”, i.e., a process for entering logs of the wireless base station device 2 therefrom. The logs of the wireless base station device 2 are entered into the remote log collection device 1 in the following procedure.

When receiving execution instructions of the process from the command reception process portion 102, the log data entry control portion 103 controls the bus interface 10e so that a request for logs is outputted to the wireless base station device 2. When the request is entered, the wireless base station device 2 starts outputting logs of processes performed by the wireless base station device 2. In particular, every time when performing some kind of process, the wireless base station device 2 outputs log data LDT indicating the contents of the process, e.g., a type of control program by which the process is performed, execution date and time, parameters and success and failure of the process, to the remote log collection device 1 that is the source of the request. Then, the bus interface 10e enters the log data LDT to make the RAM 10b store the log data LDT.

It is also possible to enter only log data LDT pertaining to a process using a control program designated by a maintenance staff, instead of entering log data LDT pertaining to all processes. In such a case, when performing operation for entering a command, the maintenance staff designates a control program for which logs are necessary. Responding to this, the log data entry control portion 103 requests the wireless base station device 2 to output only log data LDT pertaining to the process of the designated control program. The wireless base station device 2 outputs only the corresponding log data LDT.

The log data entry control portion 103 performs a process corresponding to the command number “2”, i.e., a process for stopping entry of logs of the wireless base station device 2. When the command reception process portion 102 accepts such a command, the log data entry control portion 103 controls the bus interface 10e to give the wireless base station device 2 the request to stop outputting logs. Responding to this, the wireless base station device 2 stops outputting log data LDT.

The data transmission control portion 104 performs a process corresponding to the command number “3”. More specifically, every time when log data LDT are stored in the RAM 10b, the data transmission control portion 104 controls the connection establishment interface to send the log data LDT to the maintenance terminal 3 so that a maintenance staff can browse the log data LDT in real time. The data transmission control portion 104 also performs data transmission processes corresponding to the command numbers “4” and “8”, which are described later one by one.

The data reception control portion 303 of the maintenance terminal 3 controls the dedicated network interface so as to receive the log data LDT transmitted from the remote log collection device 1. The picture display process portion 304 generates a log picture showing the contents of the log data LDT to display the log picture on the display. Further, the picture display process portion 304 generates again a log picture including the contents of log data LDT that are newly received at a later time and displays the generated log picture at an appropriate timing, e.g., every several tens of seconds to several minutes or every time when newly receiving the predetermined number of log data LDT.

Besides, the data reception control portion 303 performs control operation of reception of a log file LF, status data SDT and others that are described later. The picture display process portion 304 performs a process for displaying a picture indicating the contents of the log file LF and a picture indicating the contents of the status data SDT on the display.

The log data management portion 105 in the remote log collection device 1 performs the following processes (a) to (f) for managing a log file LF.

(a) A process for generating a log file LF in which log data LDT entered from the wireless base station device 2 is stored at a predetermined timing to save the log file LF in the hard disk drive 10d. In the present embodiment, one log file LF is generated at predetermined time everyday and is saved. Each of the log files LF is given a date, as a file name, corresponding to the date when the log file LF is generated.

(b) A process for adding log data LDT entered from the wireless base station device 2 to the log file LF generated on the same date.

(c) A process corresponding to the command number “4”. More specifically, the log file LF designated by a maintenance staff is retrieved from the hard disk drive 10d. The data transmission control portion 104 performs a control process of the connection establishment interface, and thereby the retrieved log file LF is sent to the maintenance terminal 3.

(d) A process corresponding to the command number “5”. More specifically, the log file LF designated by a maintenance staff is deleted from the hard disk drive 10d.

(e) A process corresponding to the command number “6”. More specifically, the log file LF designated by a maintenance staff is rewritten to the contents designated by the maintenance staff. Alternatively, the log file LF designated by the maintenance staff is renamed to a file name designated by the maintenance staff.

(f) A process corresponding to the command number “7”. More specifically, a file sent from the maintenance terminal 3 (a downloaded file) is saved in the hard disk drive 10d.

The status information obtaining portion 106 performs a process corresponding to the command number “8”. More specifically, the status information obtaining portion 106 collects status information indicating operation of hardware and software in the remote log collection device 1, the presence or absence of alarm and others. The data transmission control portion 104 performs a control process of the connection establishment interface, and thereby status data SDT indicating the status information are transmitted to the maintenance terminal 3.

The login process portion 101 performs a process corresponding to the command number “9” in addition to the login process described earlier. More particularly, the login process portion 101 makes a maintenance staff currently logging into the remote log collection device 1 log out thereof. After the maintenance staff logs out, the command reception process portion 102 stops accepting a command until login operation is performed again.

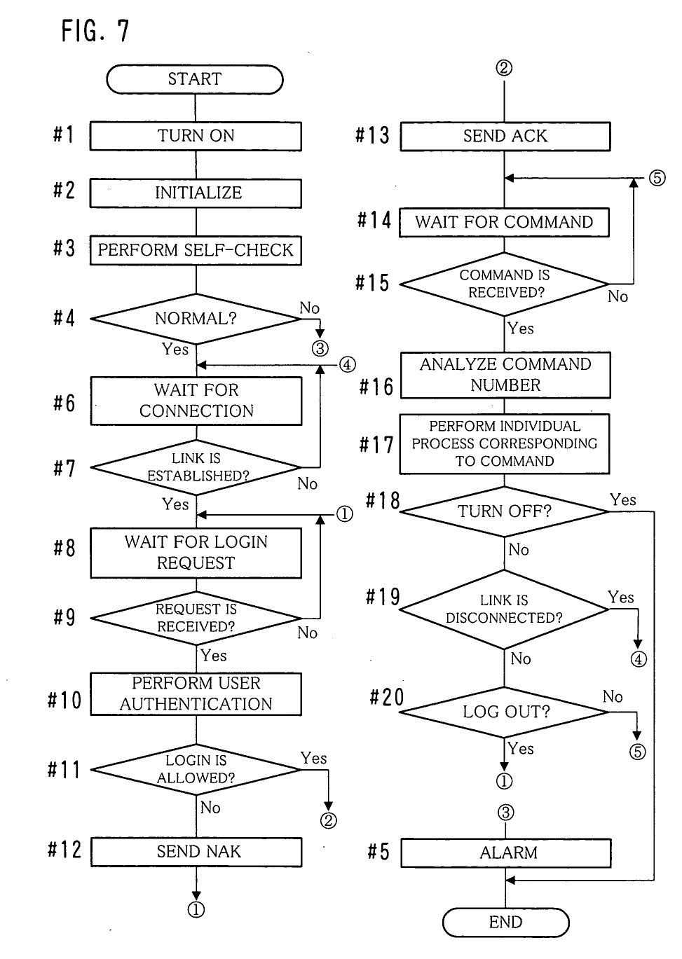

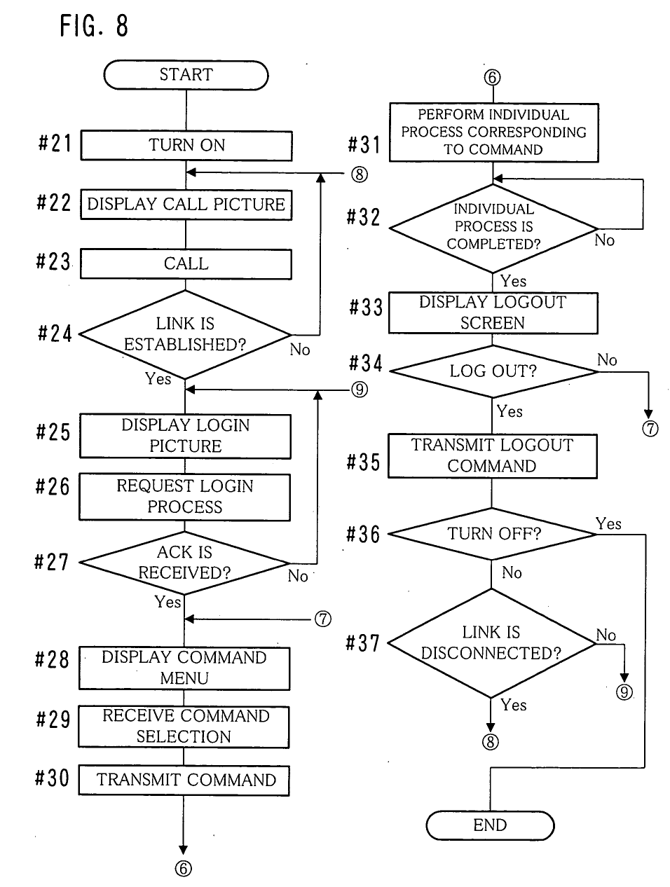

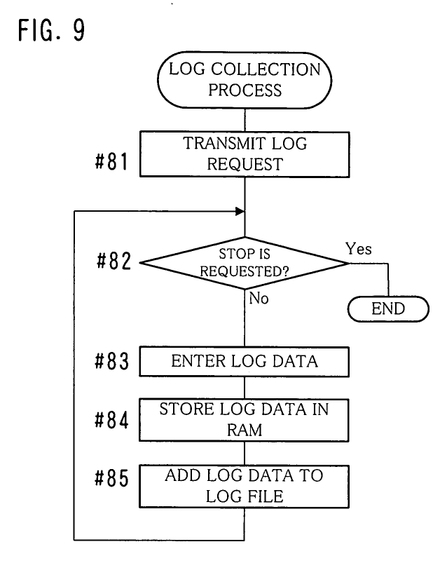

FIG. 7 is a flowchart for explaining an example of the entire process flow in the remote log collection device 1, FIG. 8 is a flowchart for explaining an example of the entire process flow in the maintenance terminal 3, and FIG. 9 is a flowchart for explaining an example of a flow of a log collection process.

Next, a description is provided, with reference to the flowcharts, of a process flow pertaining to the collection of logs of the wireless base station device 2 performed by the remote log collection device 1 and the maintenance terminal 3.

Referring to FIG. 7, the remote log collection device 1 is installed in the wireless base station device 2 that will be established. The bus interface 10e is used to connect the remote log collection device 1 to the wireless base station device 2. When being turned ON (#1), the remote log collection device 1 initializes hardware and software therein (#2). Then, the remote log collection device 1 performs self-checking operation for checking whether or not the hardware and the software are normal (#3).

When an abnormality is found (No in #4), the remote log collection device 1 runs an alarm control program and lights an alarm lamp attached to the outside of a casing (#5). When the hardware and the software are normal (Yes in #4), the remote log collection device 1 waits for establishment of the connection with the maintenance terminal 3 (#6). Further, operation of the wireless base station device 2 is started.

Referring to FIG. 8, when being turned ON (#21), the maintenance terminal 3 displays a call picture (#22) and waits for a maintenance staff to perform dial operation. When the maintenance staff selects a telephone number, the maintenance terminal 3 dials the telephone number for making a call (#23), establishes the connection (link) with the remote log collection device 1 (Yes in #24), and displays a login picture (#25). When the maintenance staff performs operation for entering an ID and a password, the maintenance terminal 3 requests the remote log collection device 1 to perform a login process (#26).

Meanwhile, when the connection between the remote log collection device 1 and the maintenance terminal 3 is established (Yes in #7) and the request for login process is accepted (Yes in #9), the remote log collection device 1 performs a user authentication process of the user of the maintenance terminal 3, i.e., the maintenance staff (#10). When it can be confirmed that the maintenance staff is an authentic user, the remote log collection device 1 allows the maintenance staff to log in (Yes in #11). Then, the remote log collection device 1 sends an ACK signal back to the maintenance terminal 3 (#13). After that, the remote log collection device 1 waits for a command from the maintenance staff (#14).

When it cannot be confirmed that the maintenance staff is an authorized user, the remote log collection device 1 rejects the login (No in #11). Then, the remote log collection device 1 sends an NAK signal back to the maintenance terminal 3 (#12) and waits for a request for login process again (#14). If it cannot be confirmed that the maintenance staff is an authorized user a predetermined number of times continuously, the remote log collection device 1 can disconnect from the maintenance terminal 3.

When receiving the ACK signal (#27), the maintenance terminal 3 displays a menu picture for selecting a command (#28) to accept command entry operation by the maintenance staff (#29). On this occasion, the maintenance staff designates parameters (a file to be processed, for example), of a process corresponding to the command if necessary. The maintenance terminal 3 transmits to the remote log collection device 1 the command and data indicating necessary parameters thus received (#30). While exchanging data with the remote log collection device 1, the maintenance terminal 3 performs an individual process corresponding to the accepted command (#31).

When receiving the command and others from the maintenance terminal 3 (Yes in #15), the remote log collection device 1 analyzes the command (#16) and performs an individual process corresponding to the command (#17).

The remote log collection device 1 and the maintenance terminal 3 perform processes individually in the following manner. When the maintenance staff selects a command corresponding to the command number “1”, the remote log collection device 1 performs a process in the procedure as shown in FIG. 9. The remote log collection device 1 requests the wireless base station device 2 connected thereto via the bus interface 10e to start outputting logs (#81). Responding to this, since the wireless base station device 2 starts outputting log data LDT, the remote log collection device 1 enters the log data LDT (#83) to store the same in the RAM 10b temporarily (#84). Then, the log data LDT are added to a predetermined log file LF (#85). The process from Step #83 through Step #85 is performed appropriately until a stop command (a command corresponding to the command number “2”) is received from the maintenance terminal 3.

When a command corresponding to the command number “2” is selected, the remote log collection device 1 requests the wireless base station device 2 to stop outputting the log data LDT. Thereby, the collection of the log data LT is stopped.

In the case of the selection of a command corresponding to the commend number “3”, every time when the log data LDT are entered from the wireless base station device 2 and are stored in the RAM 10b, the remote log collection device 1 transmits the same to the maintenance terminal 3. The maintenance terminal 3 displays the log data LDT thus received. Stated differently, the maintenance terminal 3 enables the maintenance staff to browse and monitor the contents of the log data LDT in real time.

When a command corresponding to the command number “4” is selected, the remote log collection device 1 retrieves from the hard disk drive 10d a log file LF having a file name designated by the maintenance staff and transmits the log file LF to the maintenance terminal 3. Then, the maintenance terminal 3 displays the contents of the received log file LF.

When a command corresponding to the command number “5” is selected, the remote log collection device 1 deletes from the hard disk drive 10d a log file LF having a file name designated by the maintenance staff.

When a command corresponding to the command number “6” is selected, the remote log collection device 1 edits the contents or a file name of a log file LF in accordance with the designation of the maintenance staff.

When a command corresponding to the command number “7” is selected, the remote log collection device 1 saves a file transmitted from the maintenance terminal 3 in the hard disk drive 10d.

When a command corresponding to the command number “8” is selected, the remote log collection device 1 transmits to the maintenance terminal 3 status information of hardware and software included in the remote log collection device 1 as status data STD, e.g., information including a file name and a file size of a log file LF saved in the hard disk drive 10d, a free space on the hard disk drive 10d, a size of an unused space on the RAM 10b, the availability factor of the CPU 10a and the presence or absence of alarm. The maintenance terminal 3 displays the contents of the status data SDT thus received.

After starting a process corresponding to a command given by the maintenance terminal 3, the remote log collection device 1 again waits for a command from the maintenance staff (#14). Every time when receiving a command (Yes in #15), the remote log collection device 1 performs an individual process corresponding to the command (#16).

After a process corresponding to a command given to the remote log collection device 1 is completed (Yes in #32), the maintenance terminal 3 displays a logout picture (#33). At this timing, when the maintenance staff selects a menu rather than a logout command (No in #34), the maintenance terminal 3 displays the menu picture again (#28) to wait for a command to be selected (#29).

When the logout command is selected (Yes in #34), the maintenance terminal 3 transmits the command to the remote log collection device 1 (#35).

When accepting the command (Yes in #20), the remote log collection device 1 makes the maintenance staff log out and waits for a request for login process again (#8). When a connection termination request is received from the maintenance terminal 3 or when timeout occurs (Yes in #19), the remote log collection device 1 terminates the connection with the maintenance terminal 3 and waits for the next connection (#6).

In the present embodiment, the remote log collection device 1 is so configured that communications with the wireless base station device 2 are performed using the bus interface 10e such as USB and communications with the maintenance terminal 3 are performed using the wire communications network interface 10j or the wireless communications network interface 10k. When it can be confirmed that the wireless base station device 2 newly launched operates stably and when it becomes unnecessary for a maintenance staff to monitor logs of the wireless base station device 2 in real time, the above-described configuration of the remote log collection device 1 produces the effects of easily disconnecting the remote log collection device 1 from the wireless base station device 2 and of readily using the remote log collection device 1 for other wireless base station device 2 where monitor of logs will be needed hereafter. Thus, in comparison with conventional cases, it is possible to use the remote log collection device 1 efficiently and to eliminate the functional redundancy of the entire bases (infrastructures) of the company's own mobile telephone network 70 owned by the telecommunication company X, resulting in the reduced operational cost. Further, since it is unnecessary for a maintenance staff to visit a base station each time for collecting logs, waste of time can be avoided and labor costs can be reduced.

In the present embodiment, since selection is possible that logs regarding which control programs should be collected, the complexity of information management for maintenance can be reduced.

The remote log collection device 1 is provided with the wire communications network interface 10j and the wireless communications network interface 10k. Thereby, the communications network for communicating with the maintenance terminal 3 can be used properly depending on an environment of the wireless base station device 2.

In the present embodiment, a data communications card corresponding to the other wireless communications network 72 is used as the wireless communications network interface 10k. Instead, however, a data communications card corresponding to the company's own mobile telephone network 70 can be used. Alternatively, the data communications cards of both types can be provided in the remote log collection device 1.

In the present embodiment, the remote log collection device 1 is provided with two kinds of communications interfaces of the wire communications network interface 10j and the wireless communications network interface 10k. Instead, a configuration is possible in which only either one of them is provided in the remote log collection device 1. Further, it is possible to prepare a remote log collection device only having the wire communications network interface 10j, a remote log collection device only having the wireless communications network interface 10k, and a remote log collection device having both the interfaces. Then, the remote log collection devices may be properly used depending on the installation location of the wireless base station device 2.

In the present embodiment, while the ISDN dedicated network 71 is used as a wire communications network for communicating with the maintenance terminal 3, other wire communications network can be used. The wire communications network can be, for example, an analogue telephone network for fixed-line telephones or an optical communications network.

The Ethernet (registered trademark) interface can be used as an interface for connecting the remote log collection device 1 and the wireless base station device 2.

A configuration is possible in which when being called from the maintenance terminal 3, the remote log collection device 1 calls back the maintenance terminal 3. In such a case, any one of the wire communications network interface 10j and the wireless communications network interface 10k is selected depending on an environment where the remote log collection device 1 is installed or a state of each communications network. Then, the selected interface is used for the callback.

In the present invention, a case is described, by way of example, in which log collection software is applied to a personal computer or a workstation to offer the remote log collection device 1. However, it is also possible to create a dedicated machine including configurations as shown in FIGS. 2 and 3.

In the embodiments described above, the configuration of the entire or a part of the remote log collection device 1, the wireless base station device 2 and the maintenance terminal 3, the processing contents and the processing order thereof can be modified in accordance with the spirit of the present invention.

While example embodiments of the present invention have been shown and described, it will be understood that the present invention is not limited thereto, and that various changes and modifications may be made by those skilled in the art without departing from the scope of the invention as set forth in the appended claims and their equivalents.

What is claimed is:

1. A base station log collection device that is to be placed in a location of a base station to be maintained and is used for collecting logs of the base station, the device comprising:
a base station interface that is an interface for connecting to the base station to be maintained;
a communications network interface corresponding to a communications network different from a communications network used for the base station;
a log data entry control portion for controlling the base station interface so that log data indicating contents of a process performed in the base station are entered from the base station;
a storage portion for storing the entered log data; and
a log data transmission control portion for controlling the communications network interface so that the log data stored in the storage portion are transmitted to a maintenance device used by a maintenance staff of the base station.

2. The base station log collection device according to claim 1, wherein the log data transmission control portion controls the communications network interface so that the log data are transmitted to the maintenance device based on a command issued by the maintenance device.

3. The base station log collection device according to claim 1, further comprising
as the communications network interface, a wire communications network interface corresponding to a wire communications network and a wireless communications network interface corresponding to a wireless communications network,
wherein the log data transmission control portion controls either one of the wire communications network interface and the wireless communications network interface to transmit the log data, the either one being selected by the maintenance device.

4. A method for collecting logs of a base station to be maintained, the method comprising:
placing a log collection device in a location of the base station to be maintained, the log collection device including a base station interface that is an interface for connecting to the base station, a communications network interface corresponding to a communications network different from a communications network used for the base station and a storage portion for storing data;
connecting the log collection device and the base station using the base station interface;
controlling the base station interface so that log data indicating contents of a process performed in the base station are entered into the log collection device;
letting the storage portion store the entered log data; and
controlling the communications network interface so that the log data stored in the storage portion are transmitted to a maintenance device used by a maintenance staff of the base station.

5. A computer program product for use in a computer that includes a base station interface that is an interface for connecting to a base station to be maintained, a communications network interface corresponding to a communications network different from a communications network used for the base station and a storage portion for storing data and is to be placed in a location of the base station for use, the computer program product makes the computer execute the processes comprising:
controlling the base station interface so that log data indicating contents of a process performed in the base station are entered into the log collection device;
letting the storage portion store the entered log data; and
controlling the communications network interface so that the log data stored in the storage portion are transmitted to a maintenance device used by a maintenance staff of the base station.
